(19) United States
(12) Patent Application Publication
(10) Pub. No.: US 2011/0175984 A1
(43) Pub. Date: Jul. 21, 2011

(54) METHOD AND SYSTEM OF EXTRACTING THE TARGET OBJECT DATA ON THE BASIS OF DATA CONCERNING THE COLOR AND DEPTH

(75) Inventors: Ekaterina Vitalievna TOLSTAYA, Moscow (RU); Victor Valentinovich BUCHA, Moscow (RU)

(73) Assignee: SAMSUNG ELECTRONICS CO., LTD., Suwon-si (KR)

(21) Appl. No.: 13/011,419

(22) Filed: Jan. 21, 2011

(30) Foreign Application Priority Data
Jan. 21, 2010 (RU) 2010101846

(51) Int. Cl. G06K 9/00; H04N 5/228; H04N 13/02

(52) U.S. Cl. 348/46; 382/103; 348/222.1; 348/E05.031; 348/E13.074

(57) ABSTRACT

Provided are a method and system for extracting a target object from a background image, the method including: generating a scalar image of differences between the object image and the background, using a lightness and a color difference between the background and current video frame; initializing a mask to have a value equal to a value for a corresponding pixel of a mask of a previous video frame, where a value of the scalar image of differences for the pixel is less than a threshold, and to have a predetermined value otherwise; clustering the scalar image of differences and the depth data; filling the mask for each pixel position the current video frame, using a centroid of a cluster of the scalar image of differences and the depth data; and updating the background image on the basis of the filled mask and the scalar image of differences.

### CROSS-REFERENCE TO RELATED PATENT APPLICATION

This application claims priority from Russian Patent Application No. 2010101846, filed on Jan. 21, 2010 in the Russian Agency for Patents and Trademarks, the disclosure of which is incorporated herein in its entirety by reference.

### BACKGROUND

1. Field

Apparatuses and methods consistent with exemplary embodiments relate to digital photography and, more specifically, to extracting a target object from a background image and composing the object image by generating a mask used for extracting a target object.

2. Description of the Related Art

A related art system implementing a chromakey method (i.e., method of colored rear projection) uses an evenly-lit monochromatic background for an object filming in such a way so as to enable a replacement of the background with another image afterwards (as described in “The Television Society Technical Report,” vol. 12, pp. 29-34, 1988). This system represents the simplest case, where the background is easily identified on the image. More complex cases include a non-uniform background.

Background subtraction, which is a difference between the background image without objects of interest and an observed image, has many difficult issues to overcome, such as similarly colored objects and object shadows. These problems have been addressed in various ways in the related art.

For example, in U.S. Pat. No. 6,167,167, the object's mask is determined from the object image and the background image only by introducing a threshold value of the difference between the images. However, this approach is not reliable with respect to selecting the threshold value.

In U.S. Pat. No. 6,661,918 and U.S. Pat. No. 7,317,830 the object is segmented from the background by modeling the background image, which is not available from the start. In this method, range (i.e., depth) data is used for modeling the background. However, in a case where the background image is available, the segmentation result is much more reliable.

The range (depth) data is also used in U.S. Pat. No. 6,188,777, where a Boolean mask, corresponding to a person's silhouette, is initially computed as a “union of all connected, smoothly varying range regions.” This means that for silhouette extraction, only the depth data is used. However, in case where a person is standing on the floor, the depth of the person's legs is very similar to the depth of the floor under the legs. As a result, the depth data can not be relied upon in extracting the full silhouette of the standing person.

The above-described related art methods suffer from uncertainties of the threshold value choice. If the depth data is not used, the object's mask can be unreliable because of certain limitations, such as shadows and similarly colored objects. In a case where the depth data is available and where the object of interest is positioned on some surface, a bottom of the object has the same depth value as the surface, thus the depth data alone will not provide a precise solution, and the background image is needed. Since the background conditions can change (for example, illumination, shadows, etc.), in a case of continuously monitoring the object, the image of the permanent background will drift further away from the background of the real object over time.

### SUMMARY

One or more exemplary embodiments provide a method of extracting a target object from a video sequence and a system for implementing such a method.

According to an aspect of an exemplary embodiment, there is provided a method of extracting an object image from a video sequence using an image of a background not including the object image, and using a sequence of data regarding depth, the method including: generating a scalar image of differences between the object image and the background, using a lightness difference between the background and the current video frame including the object image, and for regions of at least one pixel where the lightness difference is less than a first predetermined threshold, using a color difference between the background and the current video frame; initializing, for each pixel of the current video frame, a mask to have a value equal to a value for a corresponding pixel of a mask of a previous video frame, if the previous video frame exists, where a value of the scalar image of differences for the pixel is less than the predetermined threshold, and to have a predetermined value otherwise; clustering the scalar image of differences and the depth data on the basis of a plurality of clusters; filling the mask for each pixel position of the current video frame, using a centroid of a cluster of the scalar image of differences and the depth data, according to the clustering, for a current pixel position; and updating the background image on the basis of the filled mask and the scalar image of differences.

According to an aspect of another exemplary embodiment, there is provided a system including: at least one camera which captures images of a scene; a Color Processor which transforms data in a current video frame of the captured images into color data; a Depth (Range) processor which determines depths of pixels in the current video frame, the current video frame including an object image; a Background Processor which processes a background image for the current video frame the background image not including the object image; a Difference Estimator which computes a difference between the background image and the current video frame based on a lightness difference and a color difference between the background image and the current video frame; a Background/Foreground Discriminator which determines for each of plural pixels of the current video frame whether the pixel belongs to the background image or to the object image using the computed difference and the determined depths.

According to an aspect of another exemplary embodiment, there is provided a method of foreground object segmentation using color and depth data, the method including: receiving a background image for a current video frame, the background image not including an object image and the current video frame comprising the object image; computing a difference between the background image and the current video frame based on a lightness difference and a color difference between the background image and the current video frame; and determining for each of plural pixels of the current video frame whether the pixel belongs to the background image or the object image using the computed difference and determined depths.

Aspects of one or more exemplary embodiments provide a method of foreground object segmentation which computes the color difference only for those pixels where the lightness difference is rather insignificant; clusters the color difference data and the depth data by applying the k-means clustering; and simultaneously uses the clustered data concerning the color difference and the depth for object segmentation from video.

### BRIEF DESCRIPTION OF THE DRAWINGS

The above and/or other aspects will become more apparent by describing in detail exemplary embodiments with reference to the attached drawings in which:

FIG. 1 illustrates an operation scheme of basic components of a system which realizes a method of foreground object segmentation using color and depth data according to an exemplary embodiment;

FIG. 2 illustrates a flowchart of foreground object segmentation using color and depth data according to an exemplary embodiment;

FIG. 3 illustrates a process of computing an image of differences between a current video frame and a background image according to an exemplary embodiment; and

FIG. 4 illustrates a process of computing a mask of an object according to an exemplary embodiment.

### DETAILED DESCRIPTION OF EXEMPLARY EMBODIMENTS

Hereinafter, exemplary embodiments will be described more fully with reference to the accompanying drawings. Expressions such as “at least one of,” when preceding a list of elements, modify the entire list of elements and do not modify the individual elements of the list.

According to an exemplary embodiment, segmentation of a background object and a foreground object in an image is based upon the joint use of both depth and color data. The depth-based data is independent of the color image data, and, hence, is not affected by the limitations associated with the color-based segmentation, such as shadows and similarly colored objects.

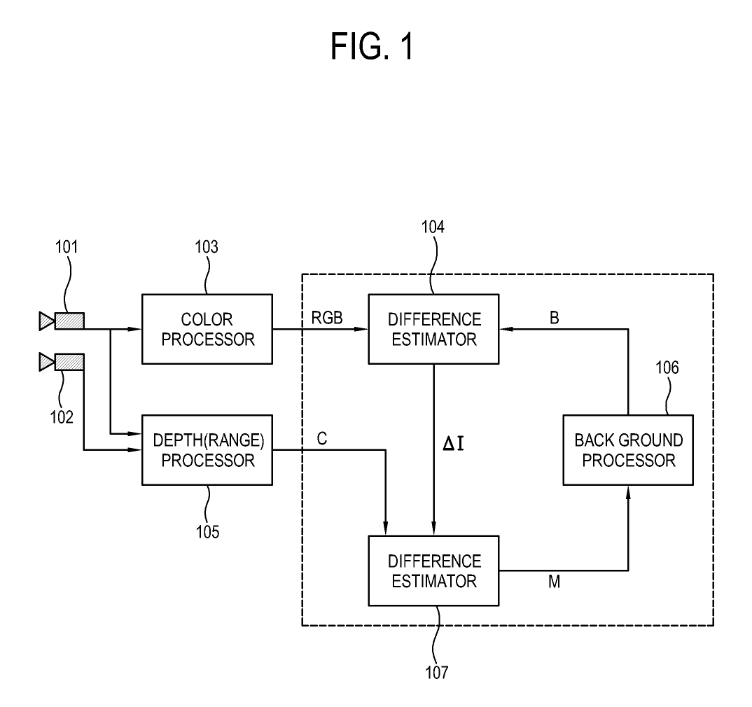

FIG. 1 shows an operation scheme of basic components of a system which realizes a method of foreground object segmentation using color and depth data in each video frame of a sequence according to an exemplary embodiment. Referring to FIG. 1, images of a scene are captured in electronic form by a pair of digital video cameras 101, 102 which are displaced from one another to provide a stereo view of the scene. These cameras 101, 102 are calibrated and generate two types of data for each pixel of each image in the video sequence. One type of data includes the color values of the pixel in RGB or another color space. At least one of the two cameras, e.g. a first camera 101, can be selected as a reference camera, and the RGB values from this camera are supplied to a Color Processor 103 as the color data for each image in a sequence of video images. The other type of data includes a distance value d for each pixel in the scene. This distance value is computed in a Depth (Range) Processor 105 by determining the correspondence between pixels in the images from each of the two cameras 101 and 102. Hereinafter, the distance between locations of corresponding pixels in the images from the two cameras 101 and 102 is referred to as disparity (or depth). Generally speaking, the disparity is inversely proportional to the distance of the object represented by that pixel. Any of numerous related art methods for disparity computation may be implemented in the Depth (Range) Processor 105.

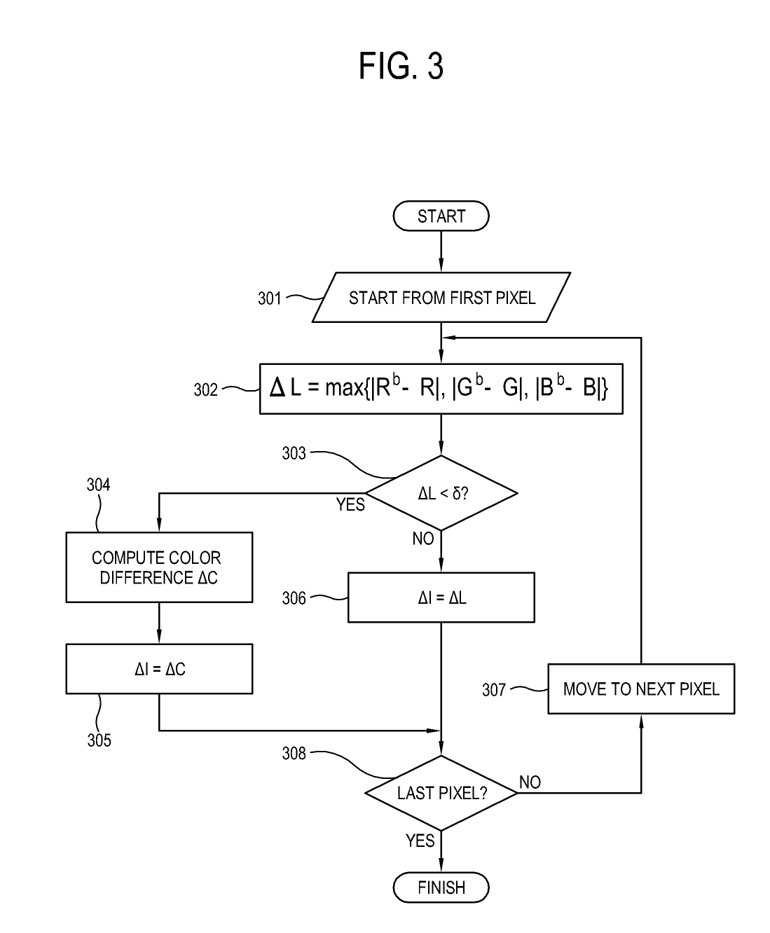

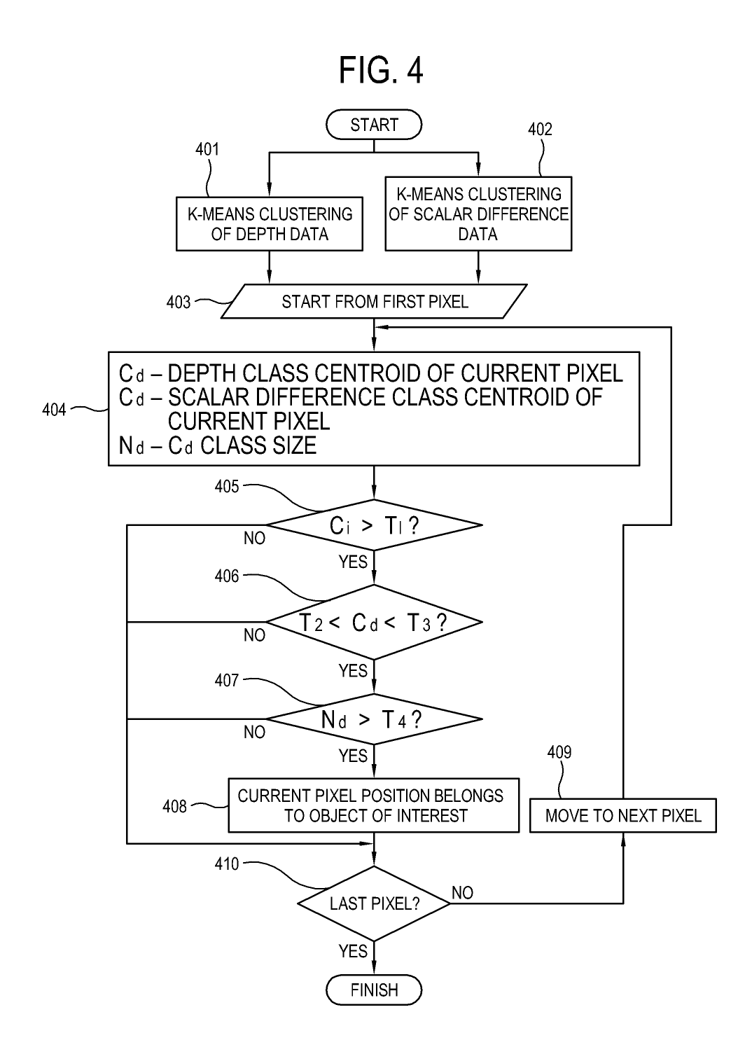

The information that is produced from the camera images includes a multidimensional data value (R, G, B, d) for each pixel in each frame of the video sequence. This data along with background image data B from a Background Processor 106 are provided to a Difference Estimator 104, which computes a lightness and color difference ΔI between the background image and the current video frame. A detailed description of the calculation will be provided below with reference to FIG. 3. In the current exemplary embodiment, the background image B is initialized at the beginning by the color digital image of the scene, which does not contain the object of interest, from the reference camera. After that, the Background/Foreground Discriminator 107 determines for each pixel whether the pixel belongs to the background, or to the object of interest, and an object mask M is constructed accordingly. For example, where the pixel belongs to the object of interest, the mask M is assigned a value of 1, and where the pixel does not belong to the object of interest, the mask M is assigned a value of 0. The operation of the Background/Foreground Discriminator 107 will be described in detail below with reference to FIG. 4. Thereafter, the Background Processor 106 updates the background image B using the object mask M, obtained from Background/Foreground Discriminator 107 (e.g., where M is equal to 0), on the basis of a current background image B_{old}, and a set parameter α, as provided in exemplary Equation (1):

B_{new}=α*B_{old}+(1−α)*I (Equation 1)

At least one component of the system can be realized as an integrated circuit device.

In another exemplary embodiment, the system includes a digital video camera 101 and a depth sensing camera 102 (for example, based on infrared pulsing and time-of-flight measurement). In this case, a reference color image corresponds to depth data available from the depth camera. Furthermore, an RGB image from the camera 101 is supplied to the Color Processor 103, and depth data is processed by the Depth Processor 105.

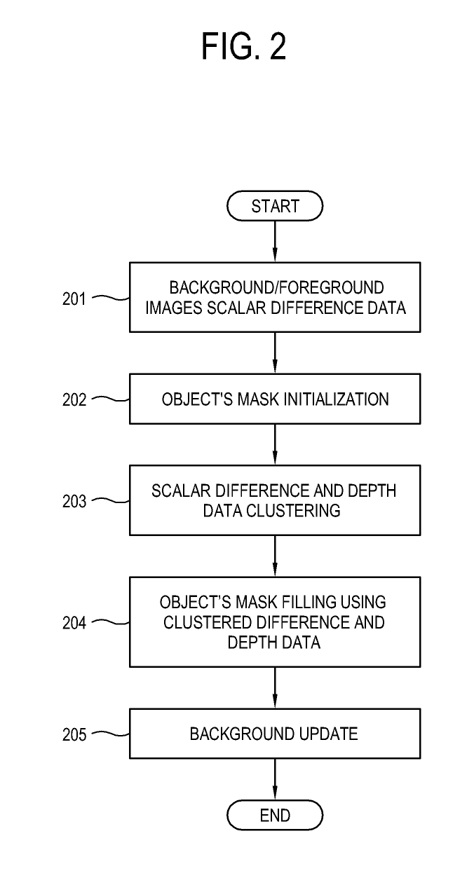

FIG. 2 illustrates a flowchart of a method of foreground object segmentation using color and depth data according to an exemplary embodiment. Referring to FIG. 2, in operation 201, a scalar image of differences between a video frame including an object and a background image is computed by the Difference Estimator 104. In operation 202, a mask of the object is initialized. In detail, for every pixel where the image difference is below a threshold, a value of the mask is set to be equal to a previous frame result. Otherwise (or in a case where data from the previous frame is not available), the value of the mask for the pixel is set to zero. In operation 203, the Background/Foreground Discriminator 107 fills the mask of the object with 0s and 1s (as described above), where 1 represents that the corresponding pixel belong to the object. In operation 204, the Background Processor 106 updates the background image using the computed mask and the current video frame, to accommodate possible changes in lighting, shadows, etc.

FIG. 3 illustrates a process of computing an image of differences between a current video frame and a background image by the Difference Estimator 104 according to an exemplary embodiment. Referring to FIG. 3, the process is carried for every pixel, starting from a first pixel (operation 301). In the present exemplary embodiment, the color image of the background is represented by I^{b}={R^{b}, G^{b}, B^{b}}, the color video frame is represented by I={R, G, B}, a lightness difference is represented by ΔL, a color difference is represented by ΔC, and an image of differences is represented by ΔI. In this case, the lightness difference and the color difference may be determined according to exemplary Equations (2) and (3):

ΔL=max{|R^{b}−R|,|G^{b}−G|,|B^{b}−B|} Equation (2), and

$$Δ C = a cos \frac{{R}^{b} * R + {G}^{b} * G + {B}^{b} * B}{\sqrt{( {R}^{{b}^{2}} + {G}^{{b}^{2}} + {B}^{{b}^{2}} ) ( {R}^{2} + {G}^{2} + {B}^{2} )}} . \qquad Equation ( 3 )$$

In operation 302, a value of a maximal difference in color channels is computed. Then, a condition (ΔL<δ) is checked in operation 303, where the constant δ may be chosen from among any value in a range of 25-30 for a 24-bit color image (where values in a color channel may vary between 0 and 255). If ΔL<δ, then the color difference is computed in operation 304, as in the above exemplary equation (3). Summarizing operations 305 and 306:

$$Δ I = \{ \begin{matrix}Δ L , & Δ L > δ \\ 0 , & Δ L = 0 , \\ Δ C , & otherwise .\end{matrix}$$

If a current pixel is a last pixel (operation 308), the process is terminated. Otherwise, the method proceeds to a next pixel (operation 307) to determine whether the next pixel belongs to the background or to the target object.

FIG. 4 illustrates a process of computing a mask of an object by the Background/Foreground Discriminator 107 according to an exemplary embodiment. Referring to FIG. 4, in operations 401 and 402, k-means clustering is performed for depth data and a scalar image of differences. For the first video frame, cluster centroids are evenly distributed in the interval [0, MAX_DEPTH] and [0, 255] correspondingly. In subsequent frames, cluster centroids are initialized from previous frames. Starting from the first pixel position (operation 403), the object's mask is filled for every pixel position. For a current pixel position, a cluster size and centroid are determined (operation 404), for which depth data and scalar difference at the current pixel position belong to:

C_{d}—depth class centroid of current pixel position,
Cᵢ—scalar difference class centroid of current pixel position, and
N_{d}—C_{d} class size.

In operations 405-407, several conditions are verified. Specifically, whether Cᵢ>T₁ (operation 405), T₂<C_{d}<T₃ (operation 406), and N_{d}>T₄ (operation 407) are determined. If all of these conditions are met, it is decided that the current pixel position belongs to an object of interest (operation 408), and the object's mask for this position is filled with 1. Otherwise, if at least one condition is not met, the object's mask at this position is set to 0. As illustrated in FIG. 4, constants T₁, T₂, T₃, and T₄ may be based on the following considerations:

T₁: image difference exceeds some value to indicate that any difference exists. In the current exemplary embodiment, T₁ is set to 10 (where a maximal possible value of Cᵢ is 255).

T₂ and T₃: T₂ may be known from a depth calculation unit, and may be the minimal depth that is defined reliably. T₃ may be estimated a priori using an input device (e.g., stereo camera) base length. Also, T₃ maybe computed from those pixels where image difference is high so that T₃ may confirm that those pixels' positions belong to object of interest.

T₄: current depth class size may be notably big. In the current exemplary embodiment, at least 10 pixel positions belong to this class (which may be less that 0.02% of total number of pixel positions).

In the present exemplary embodiment, the above-mentioned conditions combined together can deliver an accurate determination.

In operation 410, it is determined whether the current pixel is the last pixel. If so, the process terminates. Otherwise, computations are continued for a next pixel (operation 409).

After the object's mask is computed, the Background Processor 106 updates the background image B using this mask. Pixels of the background image at positions where the mask is equal to 0 and where a difference is less than a predetermined value (for example, less than 15 for 8-bit difference) are processed using a running average method, as described above with reference to exemplary Equation (1):

B_{new}=α*B_{old}+(1−α)*I Equation (1).

In exemplary Equation (1), α represents how fast the background will accommodate to changing illumination of the scene. Values close to 1 will assure slow accommodation, and values below 0.5 will provide fast accommodation. Fast accommodation may introduce irrelevant changes in the background image, which may lead to appearing artifacts in object's mask. Therefore, any value between 0.9 and 0.99 may, although not necessarily, be used to provide good results.

An exemplary embodiment may be applied in a system of human silhouette segmentation from a background for further recognition. Also, an exemplary embodiment may be used in monitors coupled with the stereo cameras, or in a system that monitors motion using a pair of digital video cameras. Other applications include interactive games, graphical special effects, etc.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, one or more units of the system according to an exemplary embodiment can include a processor or microprocessor executing a computer program stored in a computer-readable medium.

While exemplary embodiments have been particularly shown and described above, it will be understood by those of ordinary skill in the art that various changes in form and details are possible without departing from the spirit and scope of the inventive concept as defined by the appended claims. Thus, the drawings and description are to be regarded as illustrative in nature and not restrictive.

What is claimed is:

1. A method of extracting an object image from a video sequence using an image of a background not including the object image, and using a sequence of data regarding depth, corresponding to video frames of the video sequence, the method comprising:
generating a scalar image of differences between the object image and the background, using a lightness difference between the background and a current video frame comprising the object image, and for a region of at least one pixel where the lightness difference is less than a predetermined threshold, using a color difference between the background and the current video frame;
initializing, for each pixel of the current video frame, a mask to have a value equal to a value for a corresponding pixel of a mask of a previous video frame, if the previous video frame exists, where a value of the scalar image of differences for the pixel is less than the predetermined threshold, and to have a predetermined value otherwise;
clustering the scalar image of differences and the depth data on the basis of a plurality of clusters;
filling the mask for each pixel position of the current video frame, using a centroid of a cluster of the scalar image of differences and the depth data, according to the clustering, for a current pixel position; and
updating the background image on the basis of the filled mask and the scalar image of differences.

2. The method of claim 1, wherein the color difference is computed as an angle between vectors, represented by color channels values.

3. The method of claim 1, wherein the clustering is performed using a k-means clustering method.

4. The method of claim 1, wherein the filling the mask comprises determining the object's mask value using a plurality of boolean conditions about cluster properties of current pixel positions.

5. The method of claim 1, wherein the background image is updated over time using the computed mask and the current video frame.

6. The method of claim 1, wherein the generating the scalar image of differences ΔI comprises generating the scalar image of differences in accordance with:
$$Δ I = \{ \begin{matrix}Δ L , & Δ L > δ \\ 0 , & Δ L = 0 , \\ Δ C , & otherwise ,\end{matrix}$$
where the lightness difference is represented by ΔL and the color difference is represented by ΔC.

7. The method of claim 6, wherein the lightness difference ΔL is computed for each pixel in accordance with:
ΔL=max{|R^{b}−R|,|G^{b}−G|,|B^{b}−B|},
where R^{b} is a red value for the background, G^{b} is a green value for the background, B^{b} is a blue value for the background, R is a red value for the current video frame, G is a green value for the current video frame, and B is a blue value for the current video frame.

8. The method of claim 6, wherein the image color difference ΔC is computed for each pixel in accordance with:
$$Δ C = a cos \frac{{R}^{b} * R + {G}^{b} * G + {B}^{b} * B}{\sqrt{( {R}^{{b}^{2}} + {G}^{{b}^{2}} + {B}^{{b}^{2}} ) ( {R}^{2} + {G}^{2} + {B}^{2} )}} ,$$
where R^{b} is a red value for the background, G^{b} is a green value for the background, B^{b} is a blue value for the background, R is a red value for the current video frame, G is a green value for the current video frame, and B is a blue value for the current video frame.

9. The method of claim 1, wherein the predetermined value is zero.

12. A system which implements a method of foreground object segmentation using color and depth data, the system comprising:
at least one camera which captures images of a scene;
a color processor which transforms data in a current video frame of the captured images into color data;
a depth processor which determines depths of pixels in the current video frame, the current video frame comprising an object image;
a background processor which processes a background image for the current video frame, the background image not including the object image;
a difference estimator which computes a difference between the background image and the current video frame based on a lightness difference and a color difference between the background image and the current video frame, the lightness difference and the color difference being determined using the color data; and
a background/foreground discriminator which determines for each of plural pixels of the current video frame whether the pixel belongs to the background image or the object image using the computed difference and the determined depths.

13. The system of claim 12, wherein the at least one camera comprises a depth sensing camera.

14. The system of claim 12, wherein:
the at least one camera comprises a first camera which captures a first image corresponding to the current video frame and a second camera which captures a second image corresponding to the current video frame, the first and second images being combinable to form a stereoscopic image; and
the depth processor determines the depths of the pixels according to a disparity between corresponding pixels of the first and second images.

15. The system of claim 12, wherein the color data is RGB data.

16. The system of claim 12, wherein the at least one camera comprises a reference camera which captures the background image of the scene.

17. A method of foreground object segmentation using color and depth data, the method comprising:
receiving a background image for a current video frame, the background image not including an object image and the current video frame comprising the object image;
computing a difference between the background image and the current video frame based on a lightness difference and a color difference between the background image and the current video frame; and
determining for each of plural pixels of the current video frame whether the pixel belongs to the background image or the object image using the computed difference and determined depths.

18. A computer readable recording medium having recorded thereon a program executable by a computer for performing the method of claim 1.

19. A computer readable recording medium having recorded thereon a program executable by a computer for performing the method of claim 17.
